(19) United States
(12) Patent Application Publication
(10) Pub. No.: US 2024/0239953 A1
(43) Pub. Date: Jul. 18, 2024

(54) BIODEGRADABLE FILMS COMPRISING POLYHYDROXYALKANOATES

(71) Applicant: The Procter & Gamble Company, Cincinnati, OH (US)

(72) Inventors: Jing TIAN, Beijing (CN); Fangyu CHENG, Beijing (CN); Jun XU, Beijing (CN); Ping WANG, Beijing (CN); Xiaoliang CHENG, Beijing (CN); Wenlong PANG, Beijing (CN); Xiaoli WANG, Beijing (CN); Zhan CHENG, Beijing (CN)

(21) Appl. No.: 18/416,131

(22) Filed: Jan. 18, 2024

(30) Foreign Application Priority Data
Jan. 18, 2023 (WO) PCT/CN2023/072787

(51) Int. Cl. C08G 63/127; C08J 5/18; C08L 67/04

(52) U.S. Cl. CPC C08G 63/127; C08J 5/18; C08L 67/04; C08G 2230/00

(57) ABSTRACT

A biodegradable film comprises from 1 wt % to 10 wt % of a first polyhydroxyalkanoate resin component, from 50 wt % to 90 wt % of a second polyhydroxyalkanoate resin component, and from 5 wt % to 48 wt % of a polybutylene adipate terephthalate resin. Specifically, the first poly(3-hydroxybutyrate-co-3-hydroxyhexanoate) resin contains a first mol % of 3-hydroxyhexanoate structural units, and the second poly(3-hydroxybutyrate-co-3-hydroxyhexanoate) resin contains a second mol % of 3-hydroxyhexanoate structural units, while the second mol % is higher than the first mol %, e.g., by 2-40 mol %, or 3-30 mol %, or 4-20 mol %.

### CROSS REFERENCE TO RELATED APPLICATION

This application claims priority, under 35 U.S.C. § 119, to PCT Patent Application PCT/CN2023/072787, filed on Jan. 18, 2023, the entire disclosure of which is hereby incorporated by reference.

### FIELD OF THE INVENTION

The present invention relates to a biodegradable film comprising polyhydroxyalkanoates (PHAs), as well as a method of making such biodegradable film.

### BACKGROUND OF THE INVENTION

In order to alleviate the growing environmental problem of excessive plastic waste that makes up an ever more important volume fraction of what get thrown out in landfills every year, biodegradable polymers and products formed from biodegradable polymers are becoming increasingly important.

Polyhydroxyalkanoates (PHA) are a family of biopolymers either produced by synthetic methods or by a variety of microorganisms, such as bacteria and algae. Articles made from PHAS have superior biodegradability under various natural environments, including in seawater. Biodegradability in marine environments is a special challenge for many biodegradable polymers, which have much slower, and thus unsatisfactory, degradation rates in seawater. Therefore, PHA-based articles are particularly desirable due to their superior biodegradability in marine environments.

However, the technical challenges in PHA application lie in the inherent characteristics of PHA in melt strength and slow nucleation. The former makes the PHA material difficult to be thermally fabricated into desired forms, especially flexible films. The latter makes any form of PHA extrudates sticky upon extrusion and even within a few hours after extrusion, which poses challenges to the subsequent processes, such as film slitting and rewinding. Such challenges are particularly exacerbated when the PHA material is processed into films through a blown film extrusion process, in which molten PHA will be extruded through a circular extrusion die and then expanded by air pressure into a thin tubular film, which is then solidified upon cooling.

To produce films or laminates that have more acceptable processability and mechanical properties, especially suitable for the blown film extrusion process, PHA is typically blended with other less biodegradable polymeric materials, such as polybutylene adipate terephthalate (PBAT), polybutylene succinate (PBS), and/or polylactic acid (PLA). Such non-PHA polymers help to improve the processing properties and mechanical properties of the resulting resin blend. The most frequent way to use PHA is to use it as a minor part (i.e., <50 wt %) in a resin blend that also contains PBAT, PBS and/or PLA. However, the presence of such non-PHA polymer(s) in the resin blend as a major part can lead to reduced environmental degradability, especially significantly reduction of degradability in marine environments. For example, PBAT and PBS degrade slowly in seawater, and PLA shows little or no degradability in seawater, even after extended periods of time. Correspondingly, a resin blend with such less biodegradable polymer(s) as the major part has low degradability in oceans. On the other hand, decreasing the proportion of such less biodegradable polymer(s) in the resin blend tends to cause deterioration of the overall processability and mechanical properties.

There is therefore a need for improved resin blends containing the least amount of non-PHA polymer(s) possible to ensure satisfactory degradation performance, especially in seawater, but still with improved or satisfactory processability and mechanical properties to enable film-forming processes, especially the blown film extrusion process.

### SUMMARY OF THE INVENTION

The present invention provides a biodegradable film comprising PHA polymers as a major part (i.e., more than 50 wt % of the total polymeric content) and PBAT as a minor part (i.e., 5-48% of the total polymeric content). Specifically, such biodegradable film comprises a blend of at least two PHA copolymers having the same monomeric components but at different mol %, wherein said at least two PHA copolymers are provided at specific amounts. The resin composition comprising the above-described blend of PHA copolymers as a major part and PBAT as a minor part overcomes the above-mentioned challenges in thermal processing PHA feedstock into films, while maintaining the superior biodegradation performance in the resulting film.

Disclosed herein is a biodegradable film, which comprises:
(a) from 1 wt % to 10 wt % of a first polyhydroxyalkanoate resin component, which is a first poly(3-hydroxybutyrate-co-3-hydroxyhexanoate) resin comprising a first mol % of 3-hydroxyhexanoate structural units;
(b) from 50 wt % to 90 wt % of a second polyhydroxyalkanoate resin component, which is a second poly(3-hydroxybutyrate-co-3-hydroxyhexanoate) resin comprising a second mol % of 3-hydroxyhexanoate structural units, wherein said second mol % is higher than said first mol %; and
(c) from 5 wt % to 48 wt % of a biodegradable aliphatic and/or aromatic polyester.

The difference between said first and second mol % may range from 2 mol % to 40 mol %, or from 3 mol % to 30 mol %, or from 4 mol % to 20 mol %. For example, the first mol % may range from 2 mol % to 20 mol %, or from 3 mol % to 12 mol %, or from 4 mol % to 8 mol %, or from 5 mol % to 7 mol %. For example, the second mol % may range from 4 mol % to 50 mol %, or from 6 mol % to 40 mol %, or from 8 mol % to 30 mol %, or from 10 mol % to 25 mol %.

Specifically, the first polyhydroxyalkanoate resin component may be present in an amount ranging from 2 wt % to 8 wt %, or from 4 wt % to 6 wt %. The second polyhydroxyalkanoate resin component may be present in an amount ranging from 55 wt % to 80 wt %, or from 60 wt % to 75 wt %. The biodegradable aliphatic and/or aromatic polyester, which is preferably a polybutylene adipate terephthalate resin, may be present in an amount ranging from 8 wt % to 40 wt %, or from 10 wt % to 30 wt %, or from 15 wt % to 25 wt %.

The biodegradable film may further comprise from 1 wt % to 40 wt %, or from 2 wt % to 30 wt %, or from 4 wt % to 15 wt %, of one or more additives selected from the group consisting of talc, silica, calcium carbonate, boron nitride, montmorillonite, barium sulfate, zinc oxide, mica, titanium dioxide, and any combinations thereof. Optionally, said biodegradable film comprises from 1 wt % to 20 wt %, or from 2 wt % to 10 wt %, or from 4 wt % to 6 wt %, of talc.

Optionally, said biodegradable film comprises: (1) less than 5 wt % of epoxidized soybean oil; and/or (2) less than 5 wt % of a polylactic acid resin. For example, said biodegradable film may be essentially free of epoxidized soybean oil and/or polylactic acid resin.

The biodegradable film of the present invention may be characterized by one or more of the following parameters:
A thickness ranging from 10 μm to 250 μm, or from 10 μm to 150 μm, or from 20 μm to 100 μm, or from 20 μm to 50 μm; and/or
A flexural modulus ranging from 100 MPa to 2500 MPa, or from 200 MPa to 2000 MPa, or from 300 MPa to 1500 MPa, or from 400 MPa to 1000 MPa.

Also disclosed is a biodegradable resin composition, comprising:
(a) from 1 wt % to 10 wt % of a first polyhydroxyalkanoate resin component, which is a first poly(3-hydroxybutyrate-co-3-hydroxyhexanoate) resin comprising a first mol % of 3-hydroxyhexanoate structural units;
(b) from 50 wt % to 90 wt % of a second polyhydroxyalkanoate resin component, which is a second poly(3-hydroxybutyrate-co-3-hydroxyhexanoate) resin comprising a second mol % of 3-hydroxyhexanoate structural units, wherein said second mol % is higher than said first mol %;
(c) from 5 wt % to 48 wt % of a biodegradable aliphatic and/or aromatic polyester; and
(d) from 1 wt % to 40 wt % of one or more additives selected from the group consisting of talc, silica, calcium carbonate, boron nitride, montmorillonite, barium sulfate, zinc oxide and any combinations thereof.

Specifically, the biodegradable resin composition may comprise:
(a) from 4 wt % to 6 wt % of the first poly(3-hydroxybutyrate-co-3-hydroxyhexanoate) resin, which comprises from 5 mol % to 7 mol % of 3-hydroxyhexanoate structural units;
(b) from 60 wt % to 75 wt % of the poly(3-hydroxybutyrate-co-3-hydroxyhexanoate) resin, which comprises from 10 mol % to 12 mol % of 3-hydroxyhexanoate structural units;
(c) from 15 wt % to 25 wt % of the biodegradable aliphatic and/or aromatic polyester, which comprises a polybutylene adipate terephthalate resin; and
(d) from 4 wt % to 6 wt % of talc, wherein said biodegradable resin composition is essentially free of epoxidized soybean oil and/or polylactic acid resin.

Also disclosed herein is a biodegradable article formed by the above-mentioned biodegradable resin composition, and optionally said biodegradable article is essentially free of epoxidized soybean oil and/or polylactic acid resin.

Also disclosed herein is a method of making a biodegradable article, comprising the steps of:
(a) providing a first polyhydroxyalkanoate resin component, a second polyhydroxyalkanoate resin component, and a biodegradable aliphatic and/or aromatic polyester; wherein said first polyhydroxyalkanoate resin component is a first poly(3-hydroxybutyrate-co-3-hydroxyhexanoate) resin comprising a first mol % of 3-hydroxyhexanoate structural units; wherein said second polyhydroxyalkanoate resin component is a second poly(3-hydroxybutyrate-co-3-hydroxyhexanoate) resin comprising a second mol % of 3-hydroxyhexanoate structural units; wherein said second mol % is higher than said first mol %;
(b) blending said first polyhydroxyalkanoate resin component, said second polyhydroxyalkanoate resin component, and said biodegradable aliphatic and/or aromatic polyester;
(c) extruding said blend into an extrudate; and
(d) subjecting said extrudate, or a processed form thereof, to thermal extrusion to form said biodegradable article,
wherein said biodegradable article comprises from 1 wt % to 10 wt % of said first polyhydroxyalkanoate resin component, from 50 wt % to 90 wt % of said second polyhydroxyalkanoate resin component, and from 5 wt % to 48 wt % of said biodegradable aliphatic and/or aromatic polyester.

Other features and advantages of the invention will be apparent from the following detailed description, and from the claims.

### DETAILED DESCRIPTION OF THE INVENTION

Features and benefits of the various embodiments of the present invention will become apparent from the following description, which includes examples of specific embodiments intended to give a broad representation of the invention. Various modifications will be apparent to those skilled in the art from this description and from practice of the invention. The scope is not intended to be limited to the particular forms disclosed and the invention covers all modifications, equivalents, and alternatives falling within the spirit and scope of the invention as defined by the claims.

### Definitions

As used herein, the articles including “the,” “a” and “an” when used in a claim or in the specification, are understood to mean one or more of what is claimed or described.

As used herein, the terms “include,” “includes” and “including” are meant to be non-limiting.

As used herein, the terms “essentially free of” or “essentially free from” mean that the indicated material is at the very minimum not deliberately added to the composition to form part of it, or, preferably, is not present at analytically detectable levels. It is meant to include compositions whereby the indicated material is present only as an impurity in one of the other materials deliberately included.

### Polyhydroxyalkanoates (PHAs)

As mentioned hereinabove, polyhydroxyalkanoate (PHA) resins form a major component (i.e., more than 50 wt %) of the biodegradable film of the present invention.

Examples of structural units for forming the PHA resins of the present invention include 3-hydroxyalkanoate, which can be represented by the following formula (1):

{—O—CHR—CH₂—CO},

wherein R is an alkyl group represented by CₚH₂ₚ₊₁, wherein p is an integer from 1 to 15, optionally from 1 to 10, and optionally from 1 to 8. Examples of R include linear or branched alkyl groups such as methyl, ethyl, propyl, isopropyl, butyl, isobutyl, t-butyl, pentyl, and hexyl groups.

A group of particularly interesting PHA resins are homopolymers and/or copolymers containing repeating structural units of 3-hydroxybutyrate (hereinafter “P3HB”), either alone or in combination with one or more other repeating structural units.

The present invention employs a blend of at least two P3HB copolymers that contain the same monomeric components or structural units but at different mol %, while such at least two P3HB copolymers are provided at specific amounts to form a polymeric resin blend with PHAs as the major part but still with satisfactory processability and mechanical properties.

Such at least two P3HB copolymers contain 3-hydroxybutyrate repeating structural units (hereinafter “3HB”) in combination with one other type of repeating structural units, e.g., 3-hydroxypropionate, 4-hydroxybutyrate (hereinafter “4HB”), 3-hydroxyvalerate (hereinafter “3HV”), 3-hydroxyhexanoate (hereinafter “3HH”), 3-hydroxyheptanoate, 3-hydroxyoctanoate, 3-hydroxynonanoate, 3-hydroxydecanoate, 3-hydroxyundecanoate, and the like. Specifically, such at least two PHA copolymers can be poly(3-hydroxybutyrate-co-4-hydroxybutyrate) or poly(3-hydroxybutyrate-co-3-hydroxyhexanoate). More specifically, such at least two PHA copolymers can be poly(3-hydroxybutyrate-co-3-hydroxyhexanoate) containing the same 3HB and 3HH structural units, but at different mol %.

In a specific example of the present invention, such at least two P3HB copolymers include a first poly(3-hydroxybutyrate-co-3-hydroxyhexanoate) resin comprising a first mol % (i.e., x) of 3HH structural units (hereinafter “P3HB3HHₓ”), and a second poly(3-hydroxybutyrate-co-3-hydroxyhexanoate) resin comprising a second mol % (i.e., y) of 3HH structural units (hereinafter “P3HB3HH_{y}”), while said second mol % is higher than said first mol % (i.e., y>x).

The difference between said first and second mol % (i.e., y−x) can range from 2 mol % to 40 mol %, or from 3 mol % to 30 mol %, or from 4 mol % to 20 mol %. The first mol % (i.e., x) may range from 2 mol % to 20 mol %, or from 3 mol % to 12 mol %, or from 4 mol % to 8 mol %, or from 5 mol % to 7 mol %. The second mol % (i.e., y) may range from 4 mol % to 50 mol %, or from 6 mol % to 40 mol %, or from 8 mol % to 30 mol %, or from 10 mol % to 25 mol %.

The first P3HB copolymer P3HB3HHₓ with the lower first mol % (i.e., x) of the 3HH repeating structural units is characterized by a faster crystallization rate and a higher degree of crystallinity upon cooling from its molten form, which result in higher melt tensile stress and poorer melt stretchability (i.e., it is brittle and breaks under less elongation) that are not suitable for the film blowing process on its own.

In contrast, the second P3HB copolymer P3HB3HH_{y} with the higher second mol % (i.e., y) of 3HH repeating structural units is characterized by a slower crystallization rate and a lower degree of crystallinity upon cooling from its molten form, which result in lower melt tensile stress and better melt stretchability that are more suitable for the film blowing process. Therefore, the second P3HB copolymer P3HB3HH_{y} can be used as the base PHA material, i.e., in a significantly large amount ranging from 50 wt % to 90 wt %, or from 55 wt % to 80 wt %, or from 60 wt % to 75 wt %, of the total weight of the biodegradable resin composition used to form the biodegradable film of the present invention.

However, the second P3HB copolymer P3HB3HH_{y} may form very sticky blown films due to its slow crystallization rate, which causes processing challenges during winding up of such blown films. Therefore, a nucleating agent is needed to increase/modulate the crystallization rate of the biodegradable resin composition.

It is a surprising and unexpected discovery of the present invention that the first P3HB copolymer P3HB3HHₓ with the faster crystallization rate, although not suitable as a base PHA material for making blown films, can be used as an effective self-nucleating agent for the second P3HB copolymer P3HB3HH_{y} to reduce the stickiness of the resulting blown films and address challenges during winding up of such films. In such usage as the self-nucleating agent, the first P3HB copolymer P3HB3HHₓ is present in only a limited amount, i.e., from 1 wt % to 10 wt %, or from 2 wt % to 8 wt %, or from 4 wt % to 6 wt %, by total weight of the biodegradable resin composition used to form the biodegradable film of the present invention.

The weight-average molecular weight of the PHA resins used in the present invention is not limited to a particular range. Optionally, the PHA resins of the present invention is characterized by a weight-average molecular weight ranging from 100,000 to 1,000,000 Daltons, or from 200,000 to 900,000 Daltons, or from 300,000 to 800,000 Daltons. When the weight-average molecular weight of the PHA resins is below 100,000 Daltons, the mechanical properties of the resins weaken significantly and render them unsatisfactory for forming shaped articles. When the weight-average molecular weight of the PHA resins is above 1,000,000 Daltons, the processibility of the molten form of such resins reduces significantly and renders them difficult to be processed.

The weight-average molecular weight of the PHA resins can be measured as a polystyrene-equivalent molecular weight by gel permeation chromatography (HPLC GPC system manufactured by Shimadzu Corporation) using a chloroform solution of the resin or resin component. The column used in the gel permeation chromatography may be any column suitable for weight-average molecular weight measurement.

Method of producing the PHA resins is not limited to a particular technique. It may be a chemical synthesis production method or a microbial production method. Preferably but not necessarily, the PHA resins used in the present invention are microbially produced. The microbial production method used can be any known method. Known examples of bacteria that produce P3HB copolymers include Ralstonia eutropha; Aeromonas caviae; Alcaligenes eutrophus, especially that with a P3HH synthase gene introduced. Such a microorganism is cultured under suitable conditions to allow the microorganism to accumulate P3HB3HH in its cells, and the microbial cells accumulating P3HB3HH are used. Instead of the above microorganism, a genetically modified microorganism having any suitable PHA resin synthesis-related gene introduced may be used depending on the PHA resin to be produced. The culture conditions including the type of the substrate may be optimized depending on the PHA resin to be produced.

Other commercially available examples of PHA resins that can be used in the present invention include PHBV, P3HB4HB, and P3HB available from Ningbo Tianan, Ecomann, and CJ Cheiljedang.

Biodegradable Aliphatic and/or Aromatic Polyester

As mentioned hereinabove, a biodegradable aliphatic and/or aromatic polyester forms a minor component (i.e., less than 50 wt %) of the biodegradable film of the present invention. For example, the biodegradable aliphatic and/or aromatic polyester may be present in an amount ranging from 5 wt % to 48 wt %, or from 8 wt % to 40 wt %, or from 10 wt % to 30 wt %, or from 15 wt % to 25 wt %, by total weight of the biodegradable resin composition used to form the biodegradable film of the present invention.

Such biodegradable aromatic and/or aliphatic polyester can be either biologically produced or chemically synthesized. Biodegradable aliphatic and/or aromatic polyester suitable for the practice of the present invention can be a copolymer of: i) at least one aliphatic dicarboxylic acid; and/or ii) at least one aromatic dicarboxylic acid; and iii) a dihydroxy compound (diol).

The aliphatic dicarboxylic acid can be a C₂ to C₁₂ aliphatic dicarboxylic acid, such as succinic acid, glutaric acid, dimethyl glutaric acid, adipic acid, sebacic acid, or azelaic acid, and a derivative thereof (e.g., alkyl esters, acid chlorides, or their anhydrides). The aromatic dicarboxylic acid can be terephthalic acid or naphthalene dicarboxylic acid. The dihydroxy compound or diol can be a C₂-C₆ alkanediol or a C₅-C₁₀ cycloalkanediol (e.g., ethylene glycol, propylene glycol, 1,4-butanediol, 1,6-hexanediol, 1,4 cyclohexanedimethanol, and the like).

Examples of biodegradable aromatic and/or aliphatic polyesters include, but are not limited to: various co-polyesters of polyethylene terephthalate (PET) and polybutylene terephthalate (PBT) with aliphatic diacids or diols incorporated into the polymer backbone to render such co-polyesters biodegradable or compostable; and various aliphatic polyesters and co-polyesters derived from dibasic acids such as succinic acid, glutaric acid, adipic acid, sebacic acid, azelaic acid, or their derivatives (e.g., alkyl esters, acid chlorides, or their anhydrides), and diols such as ethylene glycol, propylene glycol, 1,4-butanediol, 1,6-hexanediol, 1,4 cyclohexanedimethanol, and the like. For example, the biodegradable aromatic and/or aliphatic polyester may be selected from the group consisting of polybutylene adipate terephthalate (PBAT), polybutylene succinate (PBS), polybutylene succinate adipate (PBSA), and any combinations/mixtures thereof. In a particular embodiment, the biodegradable aromatic and/or aliphatic polyester is PBAT.

In a specific embodiment of the present invention, the biodegradable resin composition used to form the biodegradable film of the present invention contains PBAT in an amount ranging from 5 wt % to 48 wt %, or from 8 wt % to 40 wt %, or from 10 wt % to 30 wt %, or from 15 wt % to 25 wt %. When PBAT is absent from the resin composition or if the amount of PBAT in the resin composition is too low, i.e., lower than 5 wt %, the resin composition suffers from low entrance pressure drop (which leads to low strain hardening and unsatisfactory film thickness uniformity of the resulting blown film) and high melt strength (which causes difficulty for the film blowing process due to more bubble breaking). As the PBAT content in the resin composition increases, the entrance pressure drop arises; and at the same time, the melt strength decreases. This indicates that with more PBAT, film blowing becomes easier, and the resulting process becomes more stable. However, continued increase of the PBAT (e.g., beyond 48%) may result in a film or shaped article with unsatisfactory biodegradability, especially in seawaters. Further, having too much PBAT in the resin composition may result in low melting enthalpy (which is indicative of low crystallinity that in turn results in film blockage or sticking to roller during the film blowing process).

Preferably but not necessarily, the PBAT is characterized by a degree of chain branching of at least 0.0005%, preferably at least 0.001%, more preferably at least 0.002%. When PBAT without any chain branching is employed, the resulting polymeric blend may have comparative lower entrance pressure drop, which may lead to lower strain hardening and reduced film thickness uniformity.

### Additives

The biodegradable film of the present invention may further comprise one or more additives selected from the group consisting of talc, silica, calcium carbonate, Boron nitride, montmorillonite, barium sulfate, zinc oxide, mica, titanium dioxide, and any combinations thereof. Biodegradable additives are particularly preferred.

Such one or more additives may be present in an amount ranging from 1 wt % to 40 wt %, or from 2 wt % to 30 wt %, or from 4 wt % to 15 wt %. Alternatively, the biodegradable film may contain little or no such one or more additives.

In a particular embodiment, the biodegradable film may comprise from 1 wt % to 20 wt %, or from 2 wt % to 10 wt %, or from 4 wt % to 6 wt % of talc.

### Other Ingredients

The biodegradable film of the present invention may further contain one or more other ingredients, as long as they do not impair the effect of the present invention. Examples of the other ingredients that can be included are: crystal nucleating agents, lubricants, plasticizers, anti-statics, flame retardants, conductive additives, heat insulators, cross-linkers, antioxidants, ultraviolet absorbers, colorants, inorganic fillers, organic fillers, hydrolysis inhibitors, and the like.

Examples of the crystal nucleating agents include pentaerythritol, orotic acid, aspartame, cyanuric acid, glycine, zinc phenylphosphonate, and boron nitride. Among these, pentaerythritol is preferred because it is particularly superior in the accelerating effect on crystallization of the PHA resin component.

Examples of the lubricants include behenamide, oleamide, erucamide, stearamide, palmitamide, N-stearyl behenamide, N-stearyl erucamide, ethylenebisstearamide, ethylenebisoleamide, ethylenebiserucamide, ethylenebislaurylamide, ethylenebiscapramide, p-phenylenebisstearamide, and a polycondensation product of ethylenediamine, stearic acid, and sebacic acid. Among these, behenamide and erucamide are preferred because they are particularly superior in the lubricating effect on the PHA resin component.

Examples of the plasticizers include epoxidized soybean oil, glycerin ester compounds, citric ester compounds, sebacic ester compounds, adipic ester compounds, polyether ester compounds, benzoic ester compounds, phthalic ester compounds, isosorbide ester compounds, polycaprolactone compounds, and dibasic ester compounds. Among these, glycerin ester compounds, citric ester compounds, sebacic ester compounds, and dibasic ester compounds are preferred because they are particularly superior in the plasticizing effect on the polyhydroxyalkanoate resin component. Examples of the glycerin ester compounds include glycerin diacetomonolaurate. Examples of the citric ester compounds include tributyl acetylcitrate. Examples of the sebacic ester compounds include dibutyl sebacate. Examples of the dibasic ester compounds include benzyl methyl diethylene glycol adipate. In addition, epoxidized soybean oil is also preferred because it is non-toxic and with superior biodegradability.

In a specific embodiment of the present invention, the biodegradable film contains less than 5 wt % of epoxidized soybean oil, and/or less than 5 wt % of a polylactic acid (PLA) resin. Optionally, such biodegradable film is essentially free of the epoxidized soybean oil and/or PLA.

### Method of Processing

For the fabrication of biodegradable articles, the biodegradable resin composition as described hereinabove is created at a temperature above the crystalline melting point of the polymeric raw materials, but below the decomposition point of any of the ingredients of the composition. Alternatively, a pre-made biodegradable resin composition of the present invention is subsequently heated to such temperature.

While in the molten condition, the resin composition is processed into a desired shape, and subsequently cooled to set the shape and induce crystallization. Such shapes can include, but are not limited to, a film, sheet, fiber, filament, rod, tube, bottle, or other shape. Such processing can be performed using any art-known technique, such as, but not limited to, extrusion, thermoforming, injection molding, compression molding, blow molding (e.g., blown film, blowing of foam), calendering, rotational molding, casting (e.g., casted sheet, casted film), and the like.

For example, the biodegradable resin composition of the present invention can be processed into a biodegradable article of a desired shape by a thermal extrusion process. As a first step, the raw materials, i.e., the first and second PHA resin components, the biodegradable aliphatic and/or aromatic polyester, and the one or more additives are mixed to form a blend, which is then extruded to form an extrudate. Such extrudate (e.g., in the shape of noodles, sheets, films, rods, and the like) or a processed form thereof (e.g., pellets or particles formed by cutting or grinding such extrudate) is subsequently thermally extruded to form a biodegradable article of the desired shape.

In a specific embodiment, the extrudate or a processed form thereof is subject to a blown film extrusion process, i.e., it is passed through a heated circular extrusion die and then expanded by air pressure into a thin tubular film that solidifies upon cooling. Specifically, the resulting blown film containing PHAs as the major part is characterized by a thickness ranging from 10 μm to 250 μm, or from 10 μm to 150 μm, or from 20 μm to 100 μm, or from 20 μm to 50 μm; and/or a flexural modulus ranging from 100 MPa to 2500 MPa, or from 200 MPa to 2000 MPa, or from 300 MPa to 1500 MPa, or from 400 MPa to 1000 MPa.

### TEST METHODS

### Test 1. Entrance Pressure Drop

The entrance pressure drop, which is indicative of the strain hardening of a polymeric blend and the corresponding thickness uniformity of the resulting blown film formed by such polymeric blend, is measured by a capillary rheology test by using a twin-bore capillary rheometer (Malvern, RH2000). The pressure sensors are mounted on the side of the left and right barrels near the bottom. The inner diameter of the barrel is 15 mm, which is equipped with a fitting piston. The entrance pressure drop of the material is measured by using both the zero-length and capillary dies.

First, the die tray of the twin-bore capillary rheometer is screwed in from the bottom of the barrel, and the capillary die is placed in the barrel from the top of the barrel. The left barrel is fitted with a long die with a 180° entry angle, a capillary diameter of 1.0 mm, and an aspect ratio (i.e., capillary length/capillary diameter) of 16. The right barrel is fitted with a one-piece zero-length die with a 180° entry angle, a capillary diameter of 1.0 mm, and an aspect ratio of 0.25.

Secondly, the software interface of the twin-bore capillary rheometer is used to set the test temperature at 160° C., the test type as the constant shear rate test, and the test sub-type as Twin-bore Bagley corrected. Different shear rates are obtained by adjusting the piston speed. The shear rates are set in the range of 20-4,000 s⁻¹ (corresponding to a piston speed of 2.25-450 mm/min), and the pre-heating time after sample loading is 6.0 min.

Samples of respective biodegradable resin compositions are dried at 50° C. for 5 hours before testing. Approximately 100 g of sample for each biodegradable resin composition is added to the left and right barrels when the set temperature reaches 160° C. The sample is filled via several additions and compacted.

Finally, the piston is installed and then operated on the software to control the piston to preload the sample until the pressure transducer indicates that the pressure has reached 1 MPa, and then the test starts. The entrance pressure drop is the value measured on the right bore at the shear rate of 2000 s⁻¹.

### Test 2. Dynamic Mechanical Analysis (DMA): Modulus

The DMA modulus, which is indicative of melt strength of a polymeric resin blend, is tested on the DMA 850 (TA instrument) using tensile clamps. The sample size is 15 mm×6.0 mm×0.25 mm.

First, the sample is clamped between an upper clamp and a lower clamp of the DMA 850 equipment. Then, the software interface of the DMA 850 is used to set the test mode as the Rate Control Strain Ramp, a test temperature of 150° C., an equilibration time of 5.0 min, a preload force of 5.0×10⁻³N, and a strain rate of 4.0%/min.

After reaching the test temperature and equilibrating for 5 min, the sample is stretched from the inherited strain to 100% strain, and the force-strain curve is recorded. The inherited strain refers to the initial strain when the sample is stretched by the gravity of the lower clamp with increasing temperature. The slope of the resulting force-strain curve is adopted as the DMA modulus.

### Test 3. Differential Scanning Calorimeter (DSC): Melting Enthalpy

The melting enthalpy of a polymeric blend, which is indicative of the crystallization and melting behaviors of such blend, can be analyzed by a differential scanning calorimeter (DSC 250, TA Instruments).

First, a flat sample of approximately 5 mg is placed in the sample pan, and then the lid is sealed to the pan using a press. The sample pan is then placed into the DSC chamber. In a nitrogen atmosphere, the sample is heated from room temperature to 180° C. at a heating rate of 10° C./min, kept for 5 min to eliminate the thermal history, and then cooled down to 10° C. at the same rate. After the first heating and cooling cycle, the sample is heated again from 10° C. to 180° C. at the same rate and the curve is recorded.

The melting enthalpy is the area of the melting peak of the second melting curve integrated using DSC software coming with the DSC 250 differential scanning calorimeter.

### EXAMPLES

### Example 1: Inventive and Comparative Biodegradable Resin Compositions with Different Entrance Pressure Drop, DMA Modulus, and DSC Melting Enthalpy Results

Thirteen (13) exemplary resin compositions with ingredients listed at below in Table 1 have been prepared, which include four (4) Inventive Samples A-D and eight (9) Comparative Samples 1-8.

TABLE 1

| | Ingredients (Wt %) | | | |
|---|---|---|---|---|
| Samples | P3HB3HHₓ¹ | P3HB3HH_{y}² | PBAT³ | Talc⁴ |
| Inventive Sample A | 5 | 70 | 20 | 5 |
| Inventive Sample B | 1.6 | 78.4 | 20 | 0 |
| Inventive Sample C | 2 | 88 | 10 | 0 |
| Inventive Sample D | 8 | 55 | 35 | 2 |
| Comparative Sample 1 | 5 | 40 | 50 | 5 |
| Comparative Sample 2 | 2 | 98 | 0 | 0 |
| Comparative Sample 3 | 5 | 95 | 0 | 0 |
| Comparative Sample 4 | 2 | 95 | 3 | 0 |
| Comparative Sample 5 | 20 | 55 | 20 | 5 |
| Comparative Sample 6 | 0 | 90 | 10 | 0 |
| Comparative Sample 7 | 0 | 80 | 20 | 0 |
| Comparative Sample 8 | 0 | 70 | 30 | 0 |
| Comparative Sample 9 | 0 | 75 | 20 | 5 |

¹BP330 from Blue PHA Co., Ltd. (Beijing, China), which is a P3HB3HH copolymer in pellet form containing 6 mol % of the 3HH repeating units and 94 mol % of the 3HB repeating units with a weight-average molecular weight of about 100,000 to 600,000 Daltons.
²BP350 from Blue PHA Co., Ltd. (Beijing, China), which is a P3HB3HH copolymer in pellet form containing 11 mol % of the 3HH repeating units and 89 mol % of the 3HB repeating units with a weight-average molecular weight of about 100,000 to 600,000 Daltons.
³TH801T from Blue Ridge Tunhe Sci. & Tech. Co., Ltd. (Xinjiang, China) with a weight-average molecular weight of about 100,000 to 160,000 Daltons.
⁴Having an average particle size of about 6.5 μm and without cladding.

Each of the above-mentioned exemplary polymeric resin blends is formed by mixing the raw materials using a Thermo Haake mixer (HAAKE Rheomix 600 OS, ThermoElectric) at 140° C. for about 5 minutes with a rotor speed of about 50 rpm. Such polymeric resin blends are then subjected to Tests 1-3 described hereinabove to measure their respective entrance pressure drop, their DMA modulus, and their DSC melting enthalpy.

For the capillary rheology test that measures entrance pressure drop, each sample polymeric resin blend is crushed by a pulverizer into particles with a diameter of 2-3 mm, which are then tested according to Test 1 as described hereinabove.

For the DMA modulus test that measures melt strength, each sample polymeric resin blend is pressed by a hot press at 150° C. and 20 MPa into a sheet having a thickness of about 0.25 mm. The sheet is cut to a size of 15 mm×6.0 mm by a punching machine and tested according to Test 2 as described hereinabove.

For the DSC melting enthalpy test, each sample polymeric resin blend is directly subjected to Test 3 as described hereinabove.

Table 2 below tabulates the respective entrance pressure drop, DMA modulus, and DSC melting enthalpy measurement results of the Inventive Resin Compositions A-D and the Comparative Resin Compositions 1-8:

TABLE 2

| | Capillary | | |
|---|---|---|---|
| | Rheology | DMA | DSC |
| | Entrance | Modulus | Melting |
| | Pressure drop | (×10⁻⁶ | enthalpy |
| Samples | (MPa) | MPa) | (J/g) |
| Inventive Sample A | 3.13 | 208 | 28.9 |
| Inventive Sample B | 2.78 | 114 | 30.4 |
| Inventive Sample C | 1.96 | 366 | 29.2 |
| Inventive Sample D | 3.24 | 226 | 33.3 |
| Comparative Sample 1 | 3.48 | 75 | 18.9 |
| Comparative Sample 2 | 1.74 | 324 | 42.8 |
| Comparative Sample 3 | 1.63 | 964 | 38.1 |
| Comparative Sample 4 | 1.42 | 392 | 35.5 |
| Comparative Sample 5 | 2.38 | 4830 | 42.2 |
| Comparative Sample 6 | 1.98 | 326 | 23.6 |
| Comparative Sample 7 | 3.01 | 223 | 22.5 |
| Comparative Sample 8 | 3.37 | 204 | 17.6 |
| Comparative Sample 9 | 3.09 | 283 | 23.3 |

The test results above demonstrate that the Inventive Resin Compositions A-D falling within the scope of the present invention are characterized by high entrance pressure drop (e.g., above 1.8 MPa), low DMA modulus (e.g., below 1500×10⁻⁶ MPa), and high DSC melting enthalpy (e.g., above 25 J/g), which are indicative of improved or satisfactory processability and mechanical properties suitable for film-forming processes, especially the blown film extrusion process. More importantly, all of the Inventive Resin Compositions A-D have PHA resin components as a major part (i.e., more than 50 wt %) and PBAT as a minor part (i.e., less than 50 wt %), which ensured satisfactory degradation, especially in seawater.

In contrast, Comparative Example 1 contains too much PBAT that will lead to reduced seawater degradation. Further, Comparative Example 1 has lower DSC melting enthalpy, which is associated with poorer crystallinity during the film blowing process that will result in film block or stickiness issues.

Comparative Examples 2-4 contain no PBAT or too little PBAT, which result in lower entrance pressure drop that correlates with poorer strain hardening of the polymeric blends and reduced thickness uniformity of the resulting blown films formed from such polymeric blends.

Comparative Example 5 contains too much P3HB3HHₓ (i.e., more than 10 wt %), and it suffers from a very high DMA modulus that is indicative of high melt strength. Such a polymeric blend will be hard to blow into bigger film bubbles to form blown films of desired thickness.

Comparative Examples 6-9 contain no P3HB3HHₓ and are characterized by low DSC melting enthalpy indicative of slow crystallinity during the film blowing process that will result in film block or stickiness issues.

### Example 2: A Biodegradable Film Formed by Blown Film Extrusion

Before compounding, the raw materials (such as the P3HB3HHₓ pellets, the P3HB3HH_{y} pellets, the PBAT pellets, and the talc) for forming the biodegradable resin composition according to the Inventive Sample A from Example 1 are dried under vacuum at 50° C. for 24 hours to remove moisture. The raw materials are then blended and granulated by using a twin-screw extruder, specifically a co-rotating twin-screw extruder (HAAKE Rheomex PTW 16/25 OS MK2, ThermoElectric) with a screw diameter of about 16 mm and a length/diameter ratio of about 40. The twin-screw extruder has a PTW die with an exit diameter of 3 mm. The temperature of the twin-screw extruder is set at 110° C., 130° C., 140° C., 150° C., 150° C., 150° C., 145° C., 140° C., 135° C., and 130° C. in sequence from the feed section to the die. The screw speed is about 100 rpm, and the feeding frequency is 2 Hz. The blend of raw materials is extruded from the die into a filament, which is then cooled by air. A pelletizer (VariCut, ThermoElectric) is used to cut such filament into pellets of about 2-2.5 mm in length.

Such pellets are then passed through a single screw extruder (HAAKE Rheomex 19/25 OS, ThermoElectric) with three heating zones and a blown film die for forming a blown film. The screw has a diameter of 19 mm and a length/diameter ratio of 25. The outer diameter of the blown film die is 25 mm, and the inner diameter is 24 mm. The temperature of the extruder is set at 145° C., 155° C., 150° C., and 145° C. from the feed section to the die. The screw speed is 10 rpm. The blow-up ratio is 3.5. The thickness of the resulting blown film is about 70-80 μm.

### Example 3: Exemplary Biodegradable Resin Compositions

Following are exemplary biodegradable resin compositions E-N that can be used to form biodegradable articles, e.g., biodegradable films or particularly biodegradable blown films, of the present invention.

TABLE 3

| Ingredients (wt %) | E | F | G | H | I | J | K | L | M | N |
|---|---|---|---|---|---|---|---|---|---|---|
| PHA-1(A) | 1 | 5 | 1 | 3 | 5 | 7 | — | | — | |
| PHA-1(B) | — | — | — | — | — | — | 1 | 3 | 5 | 3 |
| PHA-2(A) | 50 | 55 | 60 | 57 | 55 | 53 | — | | — | |
| PHA-2(B) | — | — | — | — | — | — | 70 | 50 | 60 | 50 |
| PBAT | 9 | 25 | — | — | 25 | — | 19 | 17 | — | 17 |
| Aliphatic polyester—1 | — | — | 9 | — | — | — | — | — | 15 | — |
| Aliphatic polyester—2 | — | — | — | 20 | — | 20 | — | — | — | — |
| Additive-1 | 40 | 15 | 30 | 10 | — | — | 10 | 30 | — | — |
| Additive-2 | — | — | — | — | 15 | 10 | — | — | 20 | 30 |

PHA-1(A): a P3HB3HH copolymer with 6 mol % of 3HH repeating units and 94 mol % of the 3HB repeating units with a weight-average molecular weight of about 100,000 to 600,000 Daltons.
PHA-1(B): a P3HB3HH copolymer with 5 mol % of 3HH repeating units and 95 mol % of the 3HB repeating units with a weight-average molecular weight of about 100,000 to 600,000 Daltons.
PHA-2(A): a P3HB3HH copolymer with 11 mol % of 3HH repeating units and 89 mol % of the 3HB repeating units with a weight-average molecular weight of about 100,000 to 600,000 Daltons.
PHA-2(B): a P3HB3HH copolymer with 25 mol % of 3HH repeating units and 75 mol % of the 3HB repeating units with a weight-average molecular weight of about 100,000 to 600,000 Daltons.
Aliphatic polyester-1: polybutylene succinate (PBS) with a weight-average molecular weight of about 50,000 to 400,000 Daltons.
Aliphatic polyester-2: polyethylene succinate adipate (PBSA) with a weight-average molecular weight of about 50,000 to 400,000 Daltons.
Additive-1: calcium carbonate with an average particle size of about 1 to 5 μm.
Additive-2: mica with an average particle diameter of about 1 to 10 μm and an aspect ratio of about 5 to 50.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A biodegradable film, comprising:
(a) from 1 wt % to 10 wt % of a first polyhydroxyalkanoate resin component, which is a first poly(3-hydroxybutyrate-co-3-hydroxyhexanoate) resin comprising a first mol % of 3-hydroxyhexanoate structural units;
(b) from 50 wt % to 90 wt % of a second polyhydroxyalkanoate resin component, which is a second poly(3-hydroxybutyrate-co-3-hydroxyhexanoate) resin comprising a second mol % of 3-hydroxyhexanoate structural units, wherein said second mol % is higher than said first mol %; and
(c) from 5 wt % to 48 wt % of a biodegradable aliphatic and/or aromatic polyester.

2. The biodegradable film of claim 1, wherein the difference between said first and second mol % ranges from 2 mol % to 40 mol %, or from 3 mol % to 30 mol %, or from 4 mol % to 20 mol %; wherein optionally the first mol % ranges from 2 mol % to 20 mol %, or from 3 mol % to 12 mol %, or from 4 mol % to 8 mol %, or from 5 mol % to 7 mol %; and wherein optionally the second mol % ranges from 4 mol % to 50 mol %, or from 6 mol % to 40 mol %, or from 8 mol % to 30 mol %, or from 10 mol % to 25 mol %.

3. The biodegradable film according to claim 1 or 2, wherein the first polyhydroxyalkanoate resin component is present in an amount ranging from 2 wt % to 8 wt %, or from 4 wt % to 6 wt %; and/or wherein the second polyhydroxyalkanoate resin component is present in an amount ranging from 55 wt % to 80 wt %, or from 60 wt % to 75 wt %.

4. The biodegradable film according to any one of the preceding claims, wherein the biodegradable aliphatic and/or aromatic polyester is a polybutylene adipate terephthalate resin; wherein optionally the polybutylene adipate terephthalate resin is present in an amount ranging from 8 wt % to 40 wt %, or from 10 wt % to 30 wt %, or from 15 wt % to 25 wt %.

5. The biodegradable film according to any one of the preceding claims, further comprising from 1 wt % to 40 wt %, or from 2 wt % to 30 wt %, or from 4 wt % to 15 wt %, of one or more additives selected from the group consisting of talc, silica, calcium carbonate, boron nitride, montmorillonite, barium sulfate, zinc oxide, mica, titanium dioxide, and any combinations thereof; and wherein optionally said one or more additives comprise talc.

6. The biodegradable film according to any one of the preceding claims, which comprises: (1) less than 5 wt % of epoxidized soybean oil; and/or (2) less than 5 wt % of a polylactic acid resin; and wherein optionally said biodegradable film is essentially free of epoxidized soybean oil and/or polylactic acid resin.

7. The biodegradable film according to any one of the preceding claims, which is characterized by:
A thickness ranging from 10 μm to 250 μm, or from 10 μm to 150 μm, or from 20 μm to 100 μm, or from 20 μm to 50 μm; and/or
A flexural modulus ranging from 100 MPa to 2500 MPa, or from 200 MPa to 2000 MPa, or from 300 MPa to 1500 MPa, or from 400 MPa to 1000 MPa.

8. A biodegradable resin composition, comprising:
(a) from 1 wt % to 10 wt % of a first polyhydroxyalkanoate resin component, which is a first poly(3-hydroxybutyrate-co-3-hydroxyhexanoate) resin comprising a first mol % of 3-hydroxyhexanoate structural units;
(b) from 50 wt % to 90 wt % of a second polyhydroxyalkanoate resin component, which is a second poly(3-hydroxybutyrate-co-3-hydroxyhexanoate) resin comprising a second mol % of 3-hydroxyhexanoate structural units, wherein said second mol % is higher than said first mol %;
(c) from 5 wt % to 48 wt % of a biodegradable aliphatic and/or aromatic polyester; and
(d) from 1 wt % to 40 wt % of one or more additives selected from the group consisting of talc, silica, calcium carbonate, boron nitride, montmorillonite, barium sulfate, zinc oxide, mica, titanium dioxide, and any combinations thereof.

9. The biodegradable resin composition of claim 8, which comprises:
(a) from 4 wt % to 6 wt % of the first poly(3-hydroxybutyrate-co-3-hydroxyhexanoate) resin, which comprises from 5 mol % to 7 mol % of 3-hydroxyhexanoate structural units;
(b) from 60 wt % to 75 wt % of the poly(3-hydroxybutyrate-co-3-hydroxyhexanoate) resin, which comprises from 10 mol % to 12 mol % of 3-hydroxyhexanoate structural units;
(c) from 15 wt % to 25 wt % of the biodegradable aliphatic and/or aromatic polyester, which comprises a polybutylene adipate terephthalate resin; and
(d) from 4 wt % to 6 wt % of talc.

10. A biodegradable article formed by the biodegradable resin composition of claim 8 or 9, wherein optionally said biodegradable article is essentially free of epoxidized soybean oil and/or polylactic acid resin.

11. A method of making a biodegradable article, comprising the steps of:
(a) providing a first polyhydroxyalkanoate resin component, a second polyhydroxyalkanoate resin component, and a biodegradable aliphatic and/or aromatic polyester;
wherein said first polyhydroxyalkanoate resin component is a first poly(3-hydroxybutyrate-co-3-hydroxyhexanoate) resin comprising a first mol % of 3-hydroxyhexanoate structural units; wherein said second polyhydroxyalkanoate resin component is a second poly(3-hydroxybutyrate-co-3-hydroxyhexanoate) resin comprising a second mol % of 3-hydroxyhexanoate structural units; wherein said second mol % is higher than said first mol %;
(b) blending said first polyhydroxyalkanoate resin component, said second polyhydroxyalkanoate resin component, and said biodegradable aliphatic and/or aromatic polyester to form a blend;
(c) extruding said blend into an extrudate; and
(d) subjecting said extrudate, or a processed form thereof, to thermal extrusion to form said biodegradable article,
wherein said biodegradable article comprises from 1 wt % to 10 wt % of said first polyhydroxyalkanoate resin component, from 50 wt % to 90 wt % of said second polyhydroxyalkanoate resin component, from 5 wt % to 48 wt % of said biodegradable aliphatic and/or aromatic polyester.
